(19) United States
(12) Patent Application Publication
(10) Pub. No.: US 2006/0268851 A1
(43) Pub. Date: Nov. 30, 2006

(54) Method and apparatus for address resolution protocol persistent in a network data processing system

(75) Inventors: Kavitha Vittal Murthy Baratakke, Austin, TX (US); Vinit Jain, Austin, TX (US); Vasu Vallabhaneni, Austin, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/126,121

(22) Filed: May 10, 2005

(51) Int. Cl. H04L 12/56

(52) U.S. Cl. 370/389

(57) ABSTRACT

A method, apparatus, and computer instructions for transferring data in a network data processing system. Data is transferred to a destination in which an address resolution protocol entry is used to transfer this data to the destination. A determination is made as to whether the address resolution protocol entry will expire within a selected threshold while transferring data to the destination. If the address resolution protocol will expire within the selected threshold, the address resolution protocol entry is kept or retained to reduce the interruptions or delays in the transferring of the data.

### BACKGROUND OF THE INVENTION

1. Technical Field

The present invention relates generally to an improved data processing system, and in particular, to a method and apparatus for managing data in a data processing system. Still, more particularly, the present invention relates to a method, apparatus, and computer instructions for efficiently transferring data in a network data processing system.

2. Description of Related Art

In today's computer environment, data is often transferred between different data processing systems. For example, a document or a spreadsheet may be sent from one computer in a network data processing system to another computer. Other information, such as, for example, source code, video, images, or other types of files may be sent between different computers. In transferring data between different computers, an address resolution protocol (ARP) is employed. ARP is an Internet Protocol used to map Internet Protocol (IP) addresses to media access control (MAC) addresses to facilitate communication across a medium, such as an Ethernet.

Computers identify a destination MAC address using a table, also referred to as an ARP cache. The MAC address is a hardware address that uniquely identifies each node of a network. A node may be, for example, a device, such as a network adapter. Thus, a computer may have multiple nodes if the computer has multiple network adapters. If the address needed for the destination is not located in this table, a broadcast is sent using ARP onto the network to locate the destination station. Whenever a network device wants to send data onto a network data processing system, information in the ARP table is used to accomplish this goal.

Once the source computer has determined the IP address for the destination, the source computer looks into its ARP table to locate the MAC address for the destination computer or device. If the mapping of the destination IP address to the destination MAC address is present in the table, this IP address is bound with the MAC address and used to encapsulate data. The data packet is then sent over the network to be picked up by the destination.

If the source knows the destination IP address, but is unable to locate the MAC address within its own table, an ARP request is initiated to help the device discover the MAC address. Both the MAC address and the destination IP address is needed by the destination to retain the data when data packets are received at the destination.

Currently, ARP entries have a lifetime of around twenty minutes. After this time period, the ARP entries are purged and a new ARP address is required to create or update ARP entries within the table.

Typically, from the time an ARP request is sent and a response is received, all of the packets sent by the upper layers to that destination are dropped. This process requires resending of data packets, slowing down the transfer of data. Some implementations are present, such that the outgoing packets are stored in a queue while waiting for an ARP response to be returned. This queue is typically quite small and with networks becoming faster and faster, the problem with dropped packets can be exacerbated.

For example, an application may send data much faster due to larger network speeds and the number of packets that are needed to be queued become larger and larger. With gigabyte Ethernets, more than eighty thousand packets may be generated in a second. With ten gigabyte adapters, this rate of generation may be ten times more. If the dropped packets belong to TCP connections, the TCP sender may be forced into a slow start because the TCP treats the dropped packet as a congestion event in the network. A slow start occurs by a limited number of packets being sent out and waiting for acknowledgements before sending packets at a faster rate. The packets are sent at a faster rate as more acknowledgements are received. If many TCP connections are present that are currently sending data, all of these connections will move to a slow start due to dropped packets.

Therefore, it would be advantageous to have an improved method, apparatus, and computer instructions to efficiently manage the transfer of data between different nodes.

### SUMMARY OF THE INVENTION

The present invention provides a method, apparatus, and computer instructions for transferring data in a network data processing system. Data is transferred to a destination in which an address resolution protocol entry is used to transfer this data to the destination. A determination is made as to whether the address resolution protocol entry will expire within a selected threshold while transferring data to the destination. If the address resolution protocol will expire within the selected threshold, the address resolution protocol entry is kept or retained to reduce the interruptions or delays in the transferring of the data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server depicted in accordance with a preferred embodiment of the present invention;

FIG. 3 is a block diagram illustrating a data processing system depicted in which the present invention may be implemented;

FIG. 4 is a typical software architecture for a data processing system depicted in accordance with a preferred embodiment of the present invention;

FIG. 5 is a diagram of a Transmission Control Protocol/Internet Protocol (TCP/IP) and similar protocols depicted in accordance with a preferred embodiment of the present invention;

FIG. 6 is a diagram illustrating components used in managing the transfer of data depicted in accordance with a preferred embodiment of the present invention;

FIG. 7 is an example of an ARP entry depicted in accordance with a preferred embodiment of the present invention;

FIG. 8 is a flowchart for persisting address resolution protocol entries depicted in accordance with a preferred embodiment of the present invention; and

FIG. 9 is a flowchart of a process for persisting address resolution protocol entries depicted in accordance with a preferred embodiment of the present invention.

### DETAILED DESCRIPTION OF THE PREFERRED EMBODIMENT

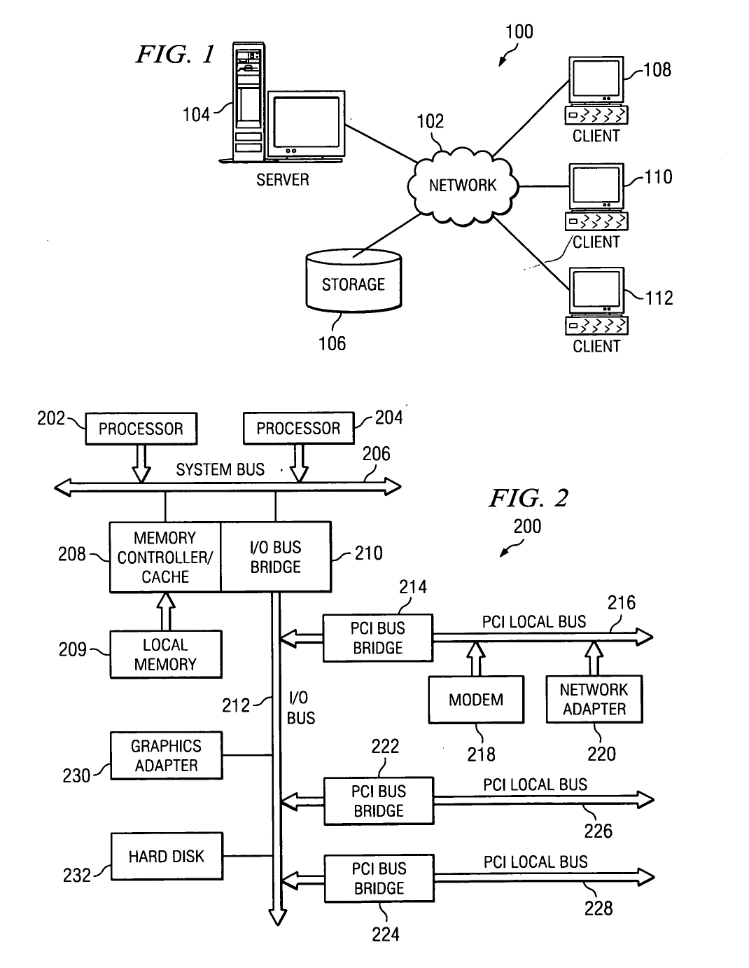

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

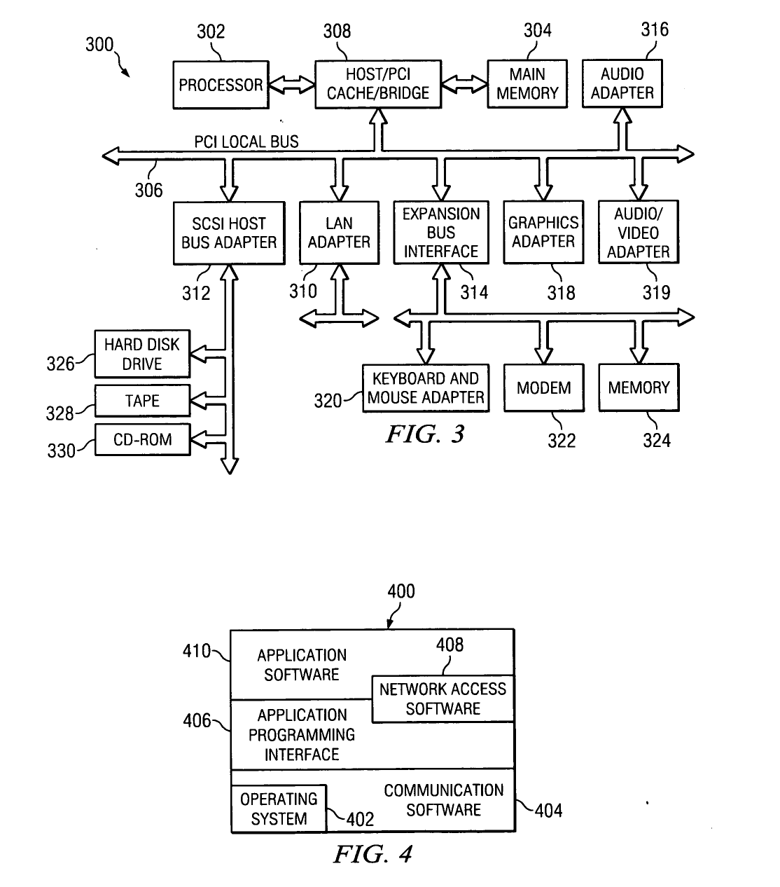

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning to FIG. 4, typical software architecture for a data processing system is depicted in accordance with a preferred embodiment of the present invention. This architecture may be implemented in a data processing system, such as data processing system 200 in FIG. 2 or data processing system 300 in FIG. 3. At the lowest level in software architecture 400, operating system 402 is utilized to provide high-level functionality to the user and to other software. Such an operating system typically includes a basic input output system (BIOS). Communication software 404 provides communications through an external port to a network such as the Internet via a physical communications link by either directly invoking operating system functionality or indirectly bypassing the operating system to access the hardware for communications over the network.

Application programming interface (API) 406 allows the user of the system, an individual, or a software routine, to invoke system capabilities using a standard consistent interface without concern for how the particular functionality is implemented. Network access software 408 represents any software available for allowing the system to access a network. This access may be to a network, such as a local area network (LAN), wide area network (WAN), or the Internet. With the Internet, this software may include programs, such as Web browsers.

Application software 410 represents any number of software applications designed to react to data through the communications port to provide the desired functionality the user seeks. Applications at this level may include those necessary to handle data, video, graphics, photos, or text, which can be accessed by users of the Internet. The mechanism of the present invention may be implemented within communications software 404 in these examples.

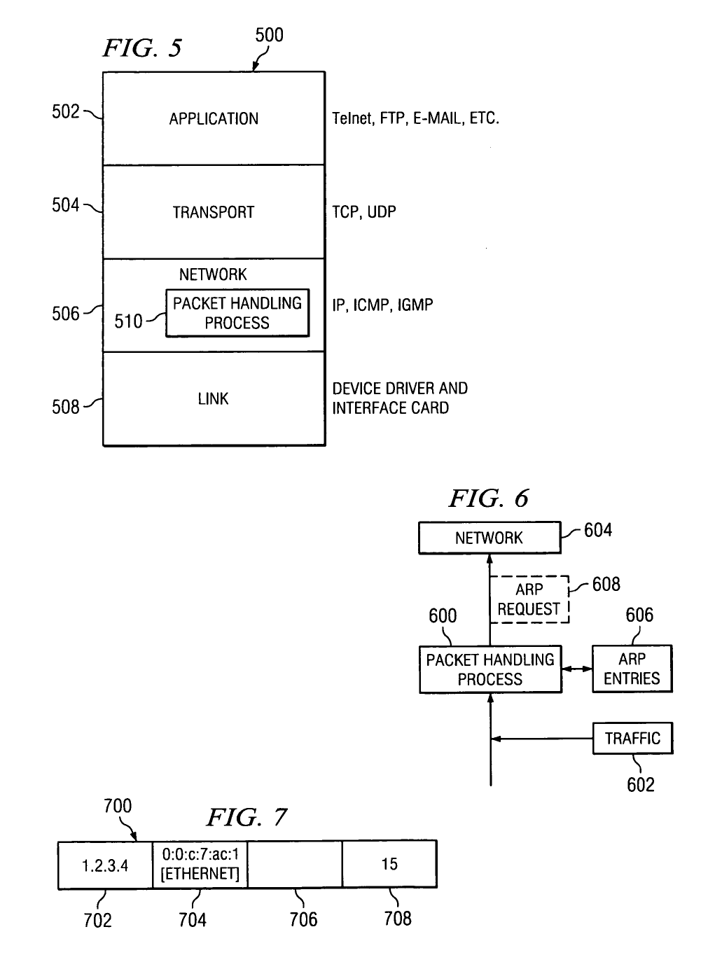

FIG. 5 is a diagram of a Transmission Control Protocol/Internet Protocol (TCP/IP) and similar protocols depicted in accordance with a preferred embodiment of the present invention. TCP/IP and similar protocols are utilized by communications architecture 500. In this example, communications architecture 500 is a 4-layer system. This architecture includes application layer 502, transport layer 504, network layer 506, and link layer 508. Each layer is responsible for handling various communications tasks. Link layer 508 also is referred to as the data-link layer or the network interface layer and normally includes the device driver in the operating system and the corresponding network interface card in the computer. This layer handles all the hardware details of physically interfacing with the network media being used, such as optical cables or Ethernet cables.

Network layer 506 also is referred to as the Internet layer and handles the movement of packets of data around the network. For example, network layer 506 handles the routing of various packets of data that are transferred over the network. Network layer 506 in the TCP/IP suite is comprised of several protocols, including Internet Protocol (IP), Internet control message protocol (ICMP), and Internet group management protocol (IGMP).

Next, transport layer 504 provides an interface between network layer 506 and application layer 502 that facilitates the transfer of data between two host computers. Transport layer 504 is concerned with things, such as, for example, dividing the data passed to it from the application into appropriately sized chunks for the network layer below, acknowledging received packets, and setting timeouts to make certain the other end acknowledges packets that are sent. In the TCP/IP protocol suite, two distinctly different transport protocols are present, TCP and user datagram protocol (UDP). TCP provides reliability services to ensure that data is properly transmitted between two hosts, including dropout detection and retransmission services.

Conversely, UDP provides a much simpler service to the application layer by merely sending packets of data called datagrams from one host to the other, without providing any mechanism for guaranteeing that the data is properly transferred. When using UDP, the application layer must perform the reliability functionality.

Application layer 502 handles the details of the particular application. Many common TCP/IP applications are present for almost every implementation, including a Telnet for remote login; a file transfer protocol (FTP); a simple mail transfer protocol (SMTP) for electronic mail; and a simple network management protocol (SNMP).

The mechanism of the present invention may be implemented as a process within network layer 506. In this illustrative example, the process is packet handling process 510.

The present invention provides a method, apparatus, and computer instructions for managing the transfer of data in a network data processing system. In particular, the mechanism of the present invention manages ARP entries in a manner that reduces dropped packets or slow starts in TCP connections. The mechanism of the present invention solves problems associated with congestion when ARP entries are purged by ensuring an ARP entry is always present when data needs to be sent. The mechanism of the present invention keeps an ARP entry current and updated before it expires by using outgoing data traffic to request these ARP updates. As a result, the entries, instead of being expired, are maintained as long as outgoing traffic is present for that particular destination. If no outgoing traffic is present, the ARP entry expires.

With reference now to FIG. 6, a diagram illustrating components used in managing the transfer of data is depicted in accordance with a preferred embodiment of the present invention. In this illustrative example, packet handling process 600 is an example of a packet handling process, such as packet handling process 510 in FIG. 5. This process monitors traffic being sent onto the network to different destinations. Whenever traffic 602 is outgoing to network 604, packet handling process 600 examines packets within traffic 602 and looks up an ARP entry within ARP entries 606. These entries are located in a data structure, such as a table or cache in these illustrative examples. In these illustrative examples, traffic 602 is destined for a single destination. In actual use, traffic 602 may contain packets for multiple destinations.

If the ARP entry for a packet in traffic 602 will expire within a selected threshold, packet handling process 600 generates and sends ARP request 608. In addition, traffic 602 is sent onto network 604 by packet handling process 600 using the ARP entry for that particular destination.

In these examples, the threshold may be sent at different times, depending on the particular implementation. For example, a threshold may be set at one minute. This threshold may be sent by a packet handling process or by a user in these illustrative examples. When a response is received for ARP request 608, the particular ARP entry is renewed before the expiration of the packet. This threshold is typically selected as one that allows for an ARP request to be sent and a response received prior to the particular entry expiring.

In this example, all packets in traffic 602 continue to go out without delay or being dropped because the ARP entry exists within ARP entries 606. When a response comes back, the entry is refreshed by resetting the expiration time for that entry. If a response is not returned before the entry expires, then the entry is deleted, purged as currently occurs and a new request is sent. Packet handling process 600 allows a user to set an option on TCP connections to instruct the TCP/IP stack to refresh the ARP entry on obtaining an indication from the transport layer that the current ARP entry is still valid. This indication may be, for example, a TCP level acknowledgement. Since the purpose of the ARP protocol is to map the IP address to the hardware address (MAC address) dynamically, taking into account any hardware changes (for instance, replacement of the Ethernet adapter), any successful exchange of packets with the current destination hardware (or MAC) address indicates that the current hardware address is still good. No need is present to send a new ARP request to determine if the hardware address has changed for that IP address. A TCP acknowledgement for data sent to that hardware address is one such indication that the current ARP entry is still good in these illustrative examples. Using the remote nodes IP address in the TCP acknowledgement packet, the ARP entry in the table may be located, and the expiration time can be reset for another 20 minutes from now. With acknowledgements constantly flowing in for data sent, this mechanism will avoid the need for purging the current entry and sending a new request. But this mechanism incurs the overhead of passing each incoming packet to the ARP processing layer. Currently, the incoming non-ARP packets are passed directly to IP. ARP module is not involved with these packets. This feature can be made user selectable (for users who think this feature is useful in spite of the extra processing involved per incoming packet) per TCP connection.

Turning next to FIG. 7, an example of an ARP entry is depicted in accordance with a preferred embodiment of the present invention. In this illustrative example, entry 700 is an ARP entry that may be found in ARP entries 606 in FIG. 6. Entry 700 contains destination address 702, MAC address 704, state 706, and expiration time 708. Destination IP address 702 is the IP address of the target or destination node. MAC address 704 is the hardware address of the target node. State 706 may contain information, such as incomplete, complete, and permanent. This information is used to tell the state of the process for obtaining information for entry 700. For example, if MAC address 704 is unknown, state 706 is incomplete. If state 700 is permanent, the user has defined an ARP entry and does not want to discover it dynamically. Expiration time 708 identifies the amount of time that entry 700 is to be retained until it is deleted or purged. In these examples, the value of expiration time 708 is decremented as time passes. In these illustrative examples, this value may be returned to the default value or incremented using the mechanism of the present invention.

With reference now to FIG. 8, a flowchart for persisting address resolution protocol entries is depicted in accordance with a preferred embodiment of the present invention. The process illustrated in FIG. 8 may be implemented in a communication process, such as packet handling process 600 in FIG. 6.

The process begins by detecting a packet for transmission (step 800). An ARP entry for a data packet is looked up in a table or cache (step 802). Next, a determination is made as to whether the ARP entry will expire within a selected threshold (step 804). If an ARP entry will not expire within the selected threshold, the process returns to step 800 to detect a packet for transmission. If the ARP entry will expire within the threshold, the ARP request is sent without deleting the ARP entry (step 806). The process is monitored for a response (step 808).

Next, a determination is made as to whether the ARP entry has expired (step 810). If ARP entry has not expired, a determination is made as to whether a response has been received (step 812). If a response has been received, the expiration time for an ARP entry is refreshed (step 814), with the process terminating thereafter.

Turning back to step 810, if an expired ARP entry is present, the ARP entry is deleted (step 816). A new ARP request is sent (step 818). With reference again to step 812, if a received response is not present, the process returns to step 808 to monitor for a response, with the process then returning to step 800 as described above.

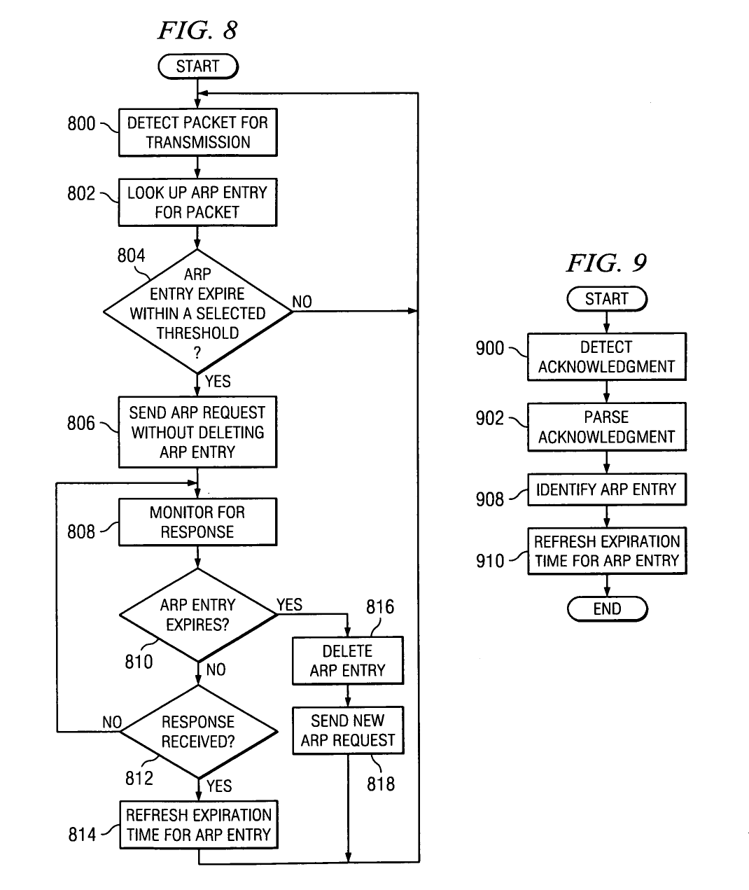

With reference next to FIG. 9, a flowchart of a process for persisting address resolution protocol entries is depicted in accordance with a preferred embodiment of the present invention. The process illustrated in FIG. 9 may be implemented in a communications process, such as packet handling process 600 in FIG. 6. This process may be implemented but increases the overhead needed to process packets. Normally, ARP is not involved in receiving data packets. The mechanism of the present invention alters the normal ARP process to include a socket option for TCP connections to instruct the TCP stack to refresh an ARP entry upon obtaining an indication from the destination that the current ARP entry is still valid.

The process begins by detecting an acknowledgement from the destination (step 900). In this example, the acknowledgement is a TCP level acknowledgement. Of course, any other response from a destination may be employed depending on the particular implementation. The acknowledgement is parsed (step 902). This parse is used to identify the IP address. The IP address is used to identify the ARP entry (step 908). This ARP entry has its expiration time refreshed (step 910) with the process terminating thereafter. In step 908, the identification of an ARP entry also may be made by using the MAC address along with the IP address although only the IP address is needed in these illustrative examples.

Thus, the present invention provides an improved method, apparatus, and computer instructions for persisting address resolution protocol entries in a network data processing system. The mechanism of the present invention resets or increments the expiration time for a particular ARP entry when data is still being sent to that particular destination. In these illustrative examples, by resetting or incrementing the expiration time for the ARP entry, the ARP entry is not purged or deleted. As a result, the process needed to refresh or obtain a new ARP entry after one has been deleted, is avoided. In this manner, slow downs and dropped packets are reduced in transferring data to a destination.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for transferring data, the method comprising:
transferring data to a destination, wherein an address resolution protocol entry is used to transfer the data to the destination;
while transferring the data to the destination, determining whether the address resolution protocol entry will expire within a selected time threshold; and
responsive to a determination the address resolution protocol entry will expire within the selected time threshold, keeping the address resolution protocol entry current.

2. The method of claim 1, wherein the determining step is initiated when a data packet is being sent out to the destination.

3. The method of claim 1, wherein the keeping step comprises:
sending an address resolution protocol request; and
responsive to receiving a response to the address resolution protocol request, refreshing an expiration time for the address resolution protocol entry.

4. The method of claim 1, wherein the keeping step comprises:
responsive to receiving an indication destination that the address resolution protocol entry is valid, refreshing an expiration time for the address resolution protocol entry.

5. The method of claim 1, wherein the destination is a node.

6. The method of claim 1, wherein the address resolution protocol entry is located in a data structure stored in the data processing system.

7. A computer program product in a data processing system for transferring data, the computer program product comprising:
first instructions, transferring data to a destination, wherein an address resolution protocol entry is used to transfer the data to the destination;
second instructions, while transferring the data to the destination, determining whether the address resolution protocol entry will expire within a selected time threshold; and
third instructions, responsive to a determination the address resolution protocol entry will expire within the selected time threshold, keeping the address resolution protocol entry current.

8. The computer program product of claim 7, wherein the determining step is initiated when a data packet is being sent out to the destination.

9. The computer program product of claim 7, wherein the third instructions comprises:
first sub-instructions for sending an address resolution protocol request; and
second sub-instructions, responsive to receiving a response to the address resolution protocol request for refreshing an expiration time for the address resolution protocol entry.

10. The computer program product of claim 7, wherein the third instructions comprises:
sub-instructions, responsive to receiving an indication destination that the address resolution protocol entry is valid for refreshing an expiration time for the address resolution protocol entry.

11. A data processing system comprising:
a bus;
a communications unit connected to the bus;
a memory connected to the bus, wherein the memory includes a set of instructions; and
a processor unit connected to the bus, wherein the processor unit executes the set of instructions to transfer data to a destination, wherein an address resolution protocol entry is used to transfer data to the destination; transfer data to the destination, and determine whether the address resolution protocol entry will expire within a selected time threshold; and responsive to a determination the address resolution protocol entry will expire within the selected time threshold, keep the address resolution protocol entry current.

12. The data processing system of claim 11, wherein the processor unit executes the instructions to determine whether the address resolution protocol entry will expire within the selected time threshold when a data packet is being sent out to the destination.

13. The data processing system of claim 11, wherein in executing the instructions to keep the address resolution protocol entry current, the processor unit executes the instructions to send an address resolution protocol request and refresh an expiration time for the address resolution protocol entry in response to receiving a response to the address resolution protocol request

14. The data processing system of claim 11, wherein in executing the instructions to keep the address resolution protocol current, the processor unit executes the instructions to refresh an expiration time for the address resolution protocol entry in response to receiving an indication destination that the address resolution protocol entry is valid.
